(19) United States
(12) Patent Application Publication
(10) Pub. No.: US 2021/0012710 A1
(43) Pub. Date: Jan. 14, 2021

(54) PIXEL DRIVING CIRCUIT, DRIVING METHOD THEREOF, AND DISPLAY DEVICE

(71) Applicant: BOE TECHNOLOGY GROUP CO., LTD., Beijing (CN)

(72) Inventors: Xiaoliang Ding, Beijing (CN); Xue Dong, Beijing (CN); Haisheng Wang, Beijing (CN); Yingming Liu, Beijing (CN); Shengji Yang, Beijing (CN); Pengpeng Wang, Beijing (CN)

(21) Appl. No.: 16/345,117

(22) PCT Filed: Aug. 24, 2018
(86) PCT No.: PCT/CN2018/102327

§ 371 Date: Apr. 25, 2019

(30) Foreign Application Priority Data
Oct. 31, 2017 (CN) 201711046552.6

(51) Int. Cl. G09G 3/3233

(52) U.S. Cl. CPC G09G 3/3233; G09G 3/32; G09G 2310/0264; G09G 2320/0233

(57) ABSTRACT

The present disclosure provides a pixel driving circuit, a driving method thereof, and a display device. The pixel driving circuit includes a current generating sub-circuit coupled to a control node and a first power signal terminal. The current generating sub-circuit is configured to output a preset current to the control node. The pixel driving circuit includes a source following sub-circuit coupled to a data signal terminal, a second power signal terminal, and the control node. The source following sub-circuit is configured to make a voltage of the control node change to follow a voltage of a data signal under the action of the preset current. The pixel driving circuit includes a light emitting element connected between the control node and the first power signal terminal to emit light under the action of the voltage of the control node.

### CROSS REFERENCE TO RELATED APPLICATIONS

The present application is based upon International Application No. PCT/CN2018/102327, filed on Aug. 24, 2018, which, which is based upon and claims the priority to the Chinese Patent Application NO. 201711046552.6, filed on Oct. 31, 2017, the entire contents of which are hereby incorporated by reference as a part of the present application.

### TECHNICAL FIELD

The present disclosure relates to the field of display technology, and in particular, to a pixel driving circuit, driving method thereof, and display device.

### BACKGROUND

Organic light emitting diode (OLED), as a current-type light emitting device, is widely used in high-performance display fields due to self-luminous, fast response, wide viewing angle, and ability to be fabricated on flexible substrates.

At present, circuit designs of OLED light emitting pixels adopt a current driving mode, and a driving transistor DTFT operates in a saturation region as a voltage-controlled current source.

### SUMMARY

The present disclosure provides a pixel driving circuit, a driving method thereof, and a display device.

According to an aspect of the present disclosure, a pixel driving circuit is provided. The pixel driving circuit includes a current generating sub-circuit coupled to a control node and a first power signal terminal. The current generation sub-circuit is configured to output a preset current to the control node. The pixel driving circuit includes a source following sub-circuit coupled to a data signal terminal, a second power signal terminal, and the control node. The source following sub-circuit is configured to change a voltage of the control node to follow a voltage of a data signal under the action of the preset current. The pixel driving circuit includes a light emitting element connected between the control node and the first power signal terminal to emit light under the action of the voltage of the control node.

In an exemplary arrangement of the present disclosure, the current generating sub-circuit includes a voltage controlled transistor. The current generating sub-circuit has a control terminal coupled to a voltage control signal terminal, a first end coupled to the first power signal terminal, and a second end coupled to the control node. The current generating sub-circuit is configured to generate and transmit the preset current to the control node in response to a voltage control signal.

In an exemplary arrangement of the present disclosure, the current generating sub-circuit includes a switching transistor. The switching transistor has a control end coupled to a scan control signal terminal, a first end coupled to a current source, and a second end coupled to the control node. The switching transistor is configured to transmit the preset current generated by the current source to the control node in response to a scan control signal.

In an exemplary arrangement of the present disclosure, the source following sub-circuit includes a source following transistor. The source following transistor has a control end coupled to the data signal terminal, a first end coupled to the second power signal terminal, and a second end coupled to the control node. The source following transistor is configured to equipotentially change the voltage of the control node to follow the voltage of the data signal under the action of the preset current.

In an exemplary arrangement of the present disclosure, the pixel driving circuit further includes a first switching element, a second switching element, and a first capacitor between the control node and the light emitting element. The first switching element has a control end coupled to a first switching signal terminal, a first end coupled to the control node, and a second end coupled to the first capacitor. The first switching element is configured to transmit and store a voltage signal of the control node to the first capacitor in response to a first switching signal. The second switching element has a control end coupled to a second switching signal terminal, a first end coupled to the first capacitor, and a second end coupled to the light emitting element. The second switching element is configured to transmit a voltage signal in the first capacitor to the light emitting element in response to a second switching signal. The first switching signal and the second switching signal are co-frequency inversion signals.

In an exemplary arrangement of the present disclosure, the pixel driving circuit further includes a second capacitor between the control node and the first switching element, and a third capacitor between the second switching element and the light emitting element.

In an exemplary arrangement of the present disclosure, all of transistors are N-type transistors or P-type transistors.

In an exemplary arrangement of the present disclosure, the light emitting element includes any one of a light emitting diode, an organic light emitting diode, and a polymer light emitting diode.

According to an aspect of the present disclosure, a pixel driving method is provided, configured to drive the pixel driving circuit described above. The pixel driving method includes outputting a preset current to a control node. The pixel driving method includes changing the voltage of the control node to follow the voltage of the data signal under the action of the preset current. The pixel driving method includes emitting light under the action of the voltage of the control node.

In an exemplary arrangement of the present disclosure, outputting the preset current to the control node includes generating and transmitting the preset current to the control node by using a voltage controlled transistor in response to a voltage control signal.

In an exemplary arrangement of the present disclosure, outputting the preset current to the control node includes transmitting the preset current generated by an external current source to the control node using a switching transistor in response to a scan control signal.

In an exemplary arrangement of the present disclosure, changing the voltage of the control node to follow the voltage of the data signal under the action of the preset current includes equipotentially changing the voltage of the control node to follow the voltage of the data signal by using a source following transistor under the action of the preset current.

In an exemplary arrangement of the present disclosure, the pixel driving method further includes transmitting and storing a voltage signal of the control node to a first capacitor by using a first switching element in response to a first switching signal. The pixel driving method further includes transmitting a voltage signal in the first capacitor to the light emitting element by using a second switching element in response to a second switching signal.

In an exemplary arrangement of the present disclosure, the light emitting element includes any one of a light emitting diode, an organic light emitting diode, and a polymer light emitting diode.

According to an aspect of the present disclosure, a display device including the above pixel driving circuit is provided.

It should be understood, the above general description and the following detailed description are merely exemplary and explanatory and is not a limiting of the present disclosure. This section provides an overview of various implementations or examples of the techniques described in the present disclosure, and is not a full disclosure of the full scope or all features of the disclosed technology.

### BRIEF DESCRIPTION OF THE DRAWINGS

The drawings, which are incorporated in the specification and constitute a part of the specification, show exemplary arrangements of the present disclosure and explain the principles of the present disclosure along with the specification. It is apparent that the drawings in the following description show only some of the arrangements of the present disclosure, and for those skilled in the art, other drawings can be obtained according to these drawings without any creative work.

FIG. 1 schematically shows a schematic diagram of a pixel driving circuit in an exemplary arrangement of the present disclosure;

FIG. 2 is a schematic structural diagram 1 of a pixel driving circuit in an exemplary arrangement of the present disclosure;

FIG. 3 is a schematic structural diagram 2 of a pixel driving circuit in an exemplary arrangement of the present disclosure;

FIG. 4 is a schematic structural diagram 3 of a pixel driving circuit in an exemplary arrangement of the present disclosure;

FIG. 5 is a schematic structural diagram 4 of a pixel driving circuit in an exemplary arrangement of the present disclosure;

FIG. 6 schematically shows a timing diagram of a switching signal in an exemplary arrangement of the present disclosure;

FIG. 7 is a schematic structural diagram 5 of a pixel driving circuit in an exemplary arrangement of the present disclosure;

FIG. 8 is a schematic structural diagram 6 of a pixel driving circuit in an exemplary arrangement of the present disclosure;

FIG. 9 schematically shows a flowchart of a pixel driving method in an exemplary arrangement of the present disclosure.

### DETAILED DESCRIPTION

Exemplary arrangements will now be described more fully with reference to the accompanying drawings. However, the arrangements can be implemented in a variety of forms and should not be construed as being limited to the examples set forth herein; rather, these arrangements are provided so that this disclosure will be more complete so as to convey the idea of the exemplary arrangements to those skilled in this art. The described features, structures, or characteristics in one or more arrangements may be combined in any suitable manner. In the following description, numerous specific details are set forth to provide a full understanding of the arrangements of the present disclosure. However, one skilled in the art will appreciate that the technical solutions of the present disclosure can be practiced when one or more of the described specific details may be omitted or other methods, components, devices, blocks, etc. may be employed. In other cases, well-known technical solutions are not shown or described in detail to avoid obscuring aspects of the present disclosure.

In addition, the drawings are merely schematic representations of the present disclosure and are not necessarily drawn to scale. The thicknesses and shapes of the various layers in the drawings do not reflect the true scale, only for the convenience of the description of the present disclosure. The same reference numerals in the drawings denote the same or similar parts, and the repeated description thereof will be omitted.

In order to accurately control a driving current, a width-to-length ratio W/L of the driving transistor DTFT cannot be too large, and as a result, a length of a driving transistor cannot be too small, which becomes a big bottleneck in high PPI (pixels per inch) pixel design. With the rapid development of technologies such as VR (virtual reality), high PPI display products have become an urgent need in the market. Therefore, how to obtain high PPI OLED products will become an important development direction in the display field.

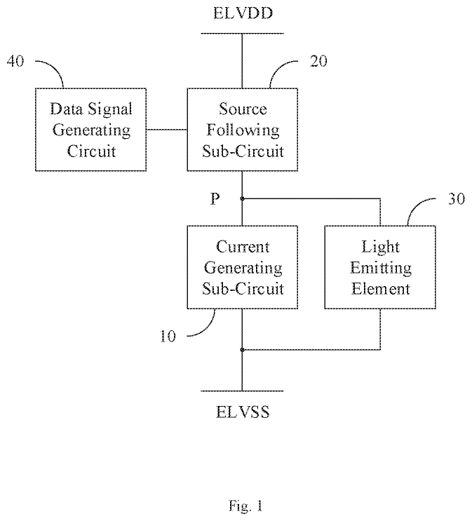

The present example arrangement provides a pixel driving circuit that can be applied to a high PPI display device. As shown in FIG. 1, the pixel driving circuit may include:

a current generating sub-circuit 10, coupled to a control node P and a first power signal terminal and configured to output a preset current to the control node P;

a source following sub-circuit 20, coupled to a data signal terminal, a second power signal terminal, and the control node P, and configured to make a voltage of the control node P change to follow a voltage of a data signal under the action of the preset current; and

a light emitting element 30, connected between the control node P and the first power signal terminal to emit light under the action of the voltage of the control node P.

In the arrangement, the current generating sub-circuit 10 is a current source of the pixel driving circuit configured to provide operating power for the entire driving circuit.

The pixel driving circuit provided by the exemplary arrangement of the present disclosure outputs the preset current by using the current generating sub-circuit 10. Since the source following sub-circuit 20 can make the voltage change of the control node P consistent with the voltage change of the data signal Data, the voltage of the control node P can be accurately controlled by adjusting the voltage of the data signal Data at the data signal terminal, so that the light emitting element 30 can be driven to emit light of different brightness in a voltage-controlled manner.

In the exemplary arrangement, the data signal terminal may be coupled to a data signal generating circuit 40 configured to provide a data signal Data. In the arrangement, the data signal generating circuit 40 should have a voltage stabilizing characteristic and a holding characteristic, which can be realized, for example, by increasing a number of storage capacitors.

It should be noted that the present arrangement only indicates the source of the data signal Data by the data signal terminal in the subsequent drawings, but it should be understood that it is merely a simplification of the data signal generating circuit 40.

Based on the pixel driving circuit, the light emitting element 30 may be any one of an OLED, an LED (light emitting diode), and a PLED (polymer light emitting diode).

In the arrangement, a light emitting layer of the OLED is a small molecule material while a light emitting layer of the PLED is a polymer material. Considering that the synthesis and purification of the small molecule material is relatively easy, the process is relatively stable, and the colorization is easy to achieve, the OLED is optionally used as the light emitting element 30 in the present arrangement.

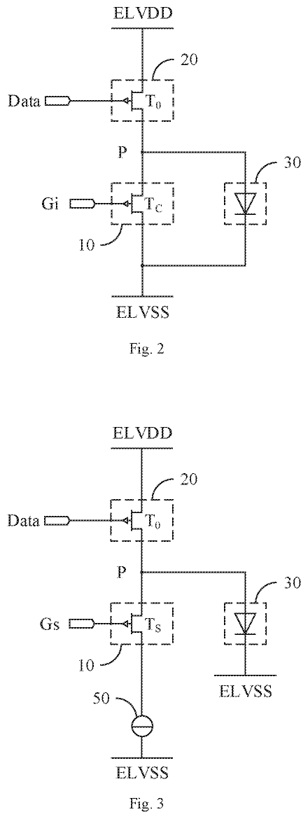

In the present exemplary arrangement, as shown in FIG. 2 to FIG. 5, the source following sub-circuit 20 may include a source following transistor TO, wherein a control terminal thereof is coupled to the data signal terminal, a first end thereof is coupled to the second power signal terminal, and a second end thereof is coupled to the control node P. The source following transistor TO may be configured to make equipotential change of the voltage of the control node P to follow the voltage of the data signal Data under the action of the preset current.

In the present arrangement, since a current of the source following transistor TO is related to a voltage difference Vgs between a gate and a source, the voltage difference Vgs between the gate and the source remain unchanged under the condition that the preset current and other conditions are constant. That is, Vg-Vs remains constant. In the arrangement, the gate voltage of the source following transistor TO is provided by the data signal Data, and the source voltage is the voltage of the control node P. In the present arrangement, a purpose of adjusting the voltage of the control node P can be achieved by adjusting the voltage of the data signal Data.

It should be noted that the source following sub-circuit 20 may further include other electronic components such as a voltage dividing resistor. The specific circuit structure of the source following sub-circuit 20 is not limited as long as it is achieved that the voltage change of the control node P follows the voltage change of the data signal Data.

In an arrangement of the present example, as shown in FIG. 2, the current generating sub-circuit 10 may include a voltage controlled transistor Tc, wherein a control terminal thereof is coupled to a voltage control signal terminal, a first end thereof is coupled to the first power signal terminal, and a second end thereof is coupled to the control node P. The voltage controlled transistor Tc is configured to generate the preset current and transmit it to the control node P in response to a voltage control signal Gi.

In the arrangement, the magnitude of the current generated in the voltage controlled transistor Tc is related to the magnitude of the voltage control signal Gi. That is to say, by adjusting the magnitude of the voltage control signal Gi, the purpose of controlling the magnitude of the preset current can be achieved.

It should be noted that in a high PPI product, the driving current of each pixel is very small (about pA level), and the preset current generated by the voltage controlled transistor Tc can reach the uA level, which is higher than the driving current by multiple orders of magnitude. Therefore, the shunting action of the light emitting element 30 does not have a large effect on the potential following effect of the control node P.

However, limited by the fabrication process of the transistor, it is difficult to ensure the process uniformity of the voltage controlled transistor Tc of different pixels, which causes a slight difference in the current generated by the voltage controlled current source, thus affecting the luminance of the light emitting element 30. In addition, since the voltage controlled transistor Tc operates in the saturation region, the operating dynamic range of the control node P is limited.

In order to solve the above problem, in another arrangement of the present example, referring to FIG. 3, the current generating sub-circuit 10 may include a switching transistor Ts, wherein a control end is coupled to a scan control signal terminal, a first end is coupled to an external current source 50, and a second end is coupled to the control node P. The switching transistor Ts is configured to transmit the preset current generated by the external current source 50 to the control node P in response to a scan control signal Gs.

In this way, since the preset current is provided by the external current source 50, the problem of the operation dynamic range of the control node P can be effectively solved; and the uniformity of different pixels is significantly improved by adopting the same one or a plurality of high-precision external current sources.

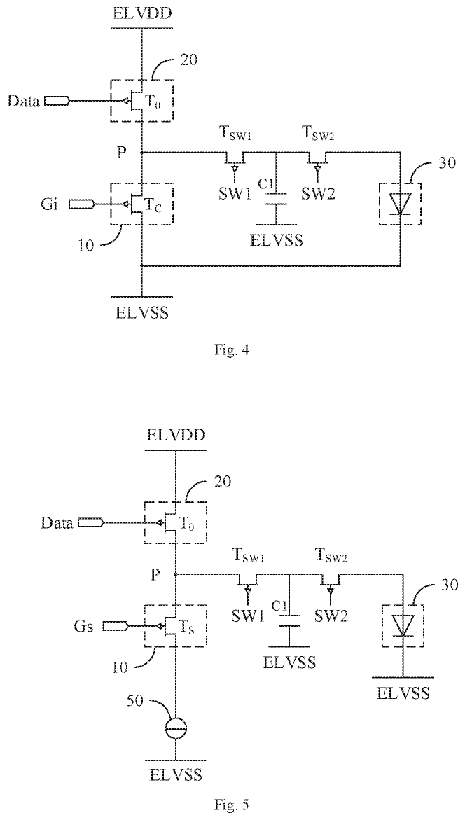

In the pixel driving circuit shown in FIG. 2 and FIG. 3, although the shunting action of the light emitting element 30 has little effect on the potential following effect of the control node P, there is still a certain influence. In order to completely eliminate the influence of the shunting action of the light emitting element 30 on the control node P, in yet another arrangement of the present example, referring to FIG. 4 and FIG. 5, the pixel driving circuit may further include a first switching element Tsw1 and a second switching element Tsw2 in series with each other between the control node P and the light emitting element 30; and a first capacitor C1, one end of the first capacitor C1 is connected between the first switching element Tsw1 and the second switching element Tsw2, and the other end is coupled to a power signal terminal such as a first power signal terminal.

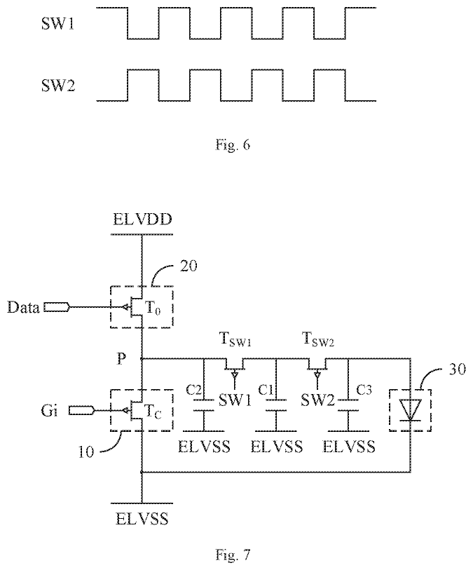

Specifically, a control end of the first switching element Tsw1 is coupled to a first switching signal terminal, a first end thereof is coupled to the control node P, and a second end thereof is coupled to the first capacitor C1. The first switching element Tsw1 can be configured to transmit and store a voltage signal of the control node P to the first capacitor C1 in response to a first switching signal SW1. a control end of the second switching element Tsw2 is coupled to a second switching signal terminal, a first end thereof is coupled to the first capacitor C1, and a second end thereof is coupled to the light emitting element 30. The second switching element Tsw2 can be configured to transmit a voltage signal in the first capacitor C1 to the light emitting element 30 in response to a second switching signal SW2. The first switching signal Tsw1 and the second switching signal Tsw2 are co-frequency inversion signals, such as the high-frequency inverse square wave signal shown in FIG. 6.

In this way, when the first switching element Tsw1 is turned on in response to the first switching signal SW1 at the first timing, the voltage signal of the control node P charges the first capacitor C1 to pull up the voltage of the first capacitor C1 to the voltage of the control node P; while when the second switching element Tsw2 is turned on in response to the second switching signal SW2 at the second timing, the first capacitor C1 can release its stored energy to drive the light emitting element 30 to emit light. By this cycle, the precise control of the illumination of the light emitting element 30 can be achieved.

It should be noted that the technical solution of adding the switching elements and the capacitors between the control node P and the light emitting element 30 is applicable not only to the arrangement in which the voltage-control transistor Tc is used as a current source in FIG. 2, but also to the arrangement in which the external current source 50 is connected in FIG. 3, which will not be described below.

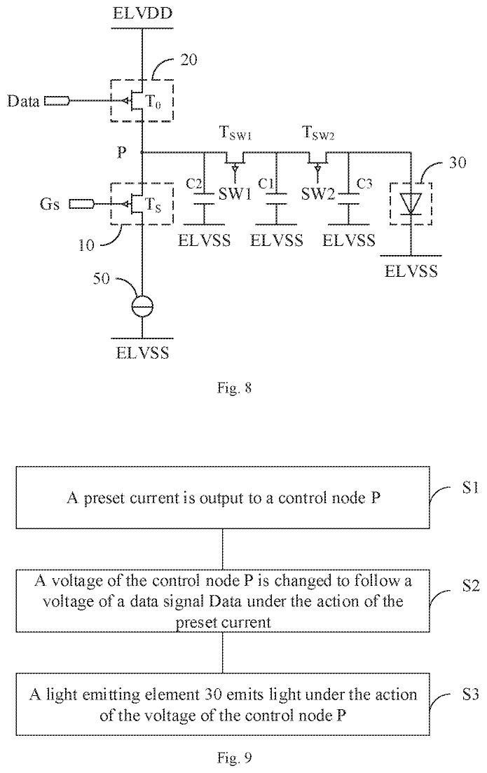

On the basis of this, in order to further improve the pixel driving capability, as shown in FIG. 7 and FIG. 8, the pixel driving circuit may further include a second capacitor C2 between the control node P and the first switching element Tsw1, and a third capacitor C3 between the second switching element Tsw2 and the light emitting element 30. In this arrangement, one end of the second capacitor C2 is connected between the control node P and the first switching element Tsw1, and the other end is coupled to the power signal terminal such as the first power signal terminal; and one end of the third capacitor C3 is connected between the second switching element Tsw2 and the light emitting elements 30, and the other end is coupled to the power signal terminal such as the first power signal terminal.

In this way, by disposing the second capacitor C2 and the third capacitor C3, charging and discharging of the multi-stage capacitor can be realized to obtain a higher driving frequency, thus ensuring that the light emitting element 30 performs light emission more stably.

It should be noted that, in addition to increasing the number of capacitors, the arrangement can also improve the pixel driving capability by increasing the capacitance, and both the above schemes can be implemented simultaneously.

In the various pixel driving circuits described above, all of the transistors and the switching elements may be N-type transistors or P-type transistors. In the arrangement, the transistor may be a field effect transistor, such as a MOS (Metal-Oxide-Semiconductor) transistor, specifically a P-type MOS transistor or an N-type MOS transistor; or the transistor may be a thin film transistor (TFT), specifically a P-type TFT or an N-type TFT.

In the arrangement, all of the transistors and the switching elements may be enhancement transistors or depletion transistors, which are not limited herein.

The example arrangement also provides a pixel driving method, configured to drive the pixel driving circuit described above. As shown in FIG. 9, the pixel driving method may include the following blocks.

In block S1, a preset current is output to a control node P;

In block S2, a voltage of the control node P is changed to follow a voltage of a data signal Data under the action of the preset current; and

In block S3, a light emitting element 30 emits light under the action of the voltage of the control node P.

In the arrangement, the light emitting element 30 may include any one of an LED, an OLED, and a PLED.

The pixel driving method provided by the exemplary arrangement of the present disclosure outputs the preset current to the control node P and make the voltage change of the control node P consistent with the voltage change of the data signal Data, the voltage of the control node P can be accurately controlled by adjusting the voltage of the data signal Data at the data signal terminal, so that the light emitting element 30 can be driven to emit light of different brightness in a voltage-controlled manner.

In the implementation of the present example, the block S1 may include generating the preset current and transmitting it to the control node P by using a voltage controlled transistor Tc in response to a voltage control signal Gi.

In another implementation of the present example, the block S1 may include transmitting the preset current generated by an external current source 50 to the control node P by using a switching transistor Ts in response to a scan control signal Gs.

Considering the slight current difference caused by the consistency of the transistor fabrication process and the operating dynamic range of the control node P, the implementation of the present example optionally employs the latter.

In the implementation of the present example, the block S2 may include causing an equipotential change of the voltage of the control node P to follow the voltage of the data signal Data by using a source following transistor TO under the action of the preset current.

On the basis of the above, in order to improve the pixel driving capability, the pixel driving method may further include:

In S4, a voltage signal of the control node P is transmitted and stored to a first capacitor C1 by using a first switching element Tsw1 in response to a first switching signal SW1; and

In S5, a voltage signal in the first capacitor C1 is transmitted to the light emitting element 30 by using a second switching element Tsw2 in response to a second switching signal SW2.

It should be noted that the specific details of the pixel driving method and the implementations thereof have been described in detail in the corresponding pixel driving circuit, and details are not described herein again.

The pixel driving method will be exemplarily described in a specific arrangement with reference to the accompanying drawings. Referring to FIG. 3, the pixel driving circuit may include a switching transistor Ts coupled to the external current source 50, a source following transistor TO receiving the data signal Data, and an OLED light emitting element 30. In the arrangement, the switching transistor Ts and the source following transistor TO are both N-type transistors, and the connection relationship can be referred to above and FIG. 3, and details are not described herein again.

Based on this, the process of the pixel driving method may include, for example, first, the scan control signal Gs is at a high level, and the switching transistor Ts is turned on to transmit the preset current generated by the external current source 50 to the control node P. Since the shunting action of the OLED light emitting element 30 has little influence on the potential following effect of the control node P, it can be ignored. At this time, the data signal Data is at a high level, and under the action of the preset current, based on the potential following effect of the source-following transistor TO, the voltage of the control node P equipotentially changes to follow the voltage of the data signal Data, therefore, the voltage of the control node P needed can be obtained by controlling the voltage of the data signal Data. Finally, the OLED light emitting element 30 emits light with a corresponding brightness according to the voltage of the control node P.

Of course, in order to improve the illuminating stability of the OLED light emitting element 30 and further improve the control precision thereof, the switching elements and the storage capacitors may be added between the control node P and the OLED light emitting element 30, specifically referring to the technical solution as shown in FIG. 5 and FIG. 8.

The exemplary arrangement also provides a display device including the above-described pixel driving circuit. The display device may include: a plurality of scan lines configured to provide scan signals; a plurality of data lines configured to provide data signals; and a plurality of pixel driving circuits electrically coupled to the scan lines and the data lines; wherein at least one of the pixel driving circuits includes any of the above-described pixel driving circuits in the present exemplary arrangement.

In the arrangement, the display device may be any one of an LED display device, an OLED display device, and a PLED display device.

It should be noted that the display device may include any product or component having a display function, such as a mobile phone, a tablet computer, a television, a notebook computer, a digital photo frame, a navigator, and the like.

The pixel driving circuit and the driving method thereof provided by the exemplary arrangements of the present disclosure output the preset current by using the current generating sub-circuit. Since the source following sub-circuit can make the voltage change of the control node consistent with the voltage change of the data signal, the voltage of the control node can be accurately controlled by adjusting the voltage of the data signal at the data signal terminal, so that the light emitting element can be driven to emit light of different brightness in a voltage-controlled manner.

Other arrangements of the present disclosure will be readily apparent to those skilled in the art upon consideration of the specification and practice of the present disclosure herein disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and examples are to be considered as illustrative only, the true scope and spirit of the present disclosure is pointed out by the following claims.

It should be understood that the present disclosure is not limited to the precise structure that has been described above and illustrated in the drawings, and various modifications and changes can be made without departing from the scope thereof. The scope of the present disclosure is limited only by the appended claims.

1. A pixel driving circuit, comprising:
a current generating sub-circuit, coupled to a control node and a first power signal terminal, and configured to output a preset current to the control node;
a source following sub-circuit, coupled to a data signal terminal, a second power signal terminal, and the control node, and configured to change a voltage of the control node to follow a voltage of a data signal under an action of the preset current; and
a light emitting element, connected between the control node and the first power signal terminal to emit light under an action of the voltage of the control node.

2. The pixel driving circuit according to claim 1, wherein the current generating sub-circuit comprises:
a voltage controlled transistor having a control terminal coupled to a voltage control signal terminal, a first end coupled to the first power signal terminal, and a second end coupled to the control node, and configured to generate and transmit the preset current to the control node in response to a voltage control signal.

3. The pixel driving circuit according to claim 1, wherein the current generating sub-circuit comprises:
a switching transistor having a control end coupled to a scan control signal terminal, a first end coupled to a current source, and a second end coupled to the control node, and configured to transmit the preset current generated by the current source to the control node in response to a scan control signal.

4. The pixel driving circuit according to claim 1, wherein the source following sub-circuit comprises:
a source following transistor having a control end coupled to the data signal terminal, a first end coupled to the second power signal terminal, and a second end coupled to the control node, and configured to equipotentially change the voltage of the control node to follow the voltage of the data signal under the action of the preset current.

5. The pixel driving circuit according to claim 2, wherein the pixel driving circuit further comprises a first switching element, a second switching element, and a first capacitor between the control node and the light emitting element;
the first switching element has a control end coupled to a first switching signal terminal, a first end coupled to the control node, and a second end coupled to the first capacitor, and is configured to transmit and store a voltage signal of the control node to the first capacitor in response to a first switching signal;
the second switching element has a control end coupled to a second switching signal terminal, a first end coupled to the first capacitor, and a second end coupled to the light emitting element, and is configured to transmit a voltage signal in the first capacitor to the light emitting element in response to a second switching signal; and
wherein the first switching signal and the second switching signal are co-frequency inversion signals.

6. The pixel driving circuit according to claim 3, wherein the pixel driving circuit further comprises a first switching element, a second switching element, and a first capacitor between the control node and the light emitting element;
the first switching element has a control end coupled to a first switching signal terminal, a first end coupled to the control node, and a second end coupled to the first capacitor, and is configured to transmit and store a voltage signal of the control node to the first capacitor in response to a first switching signal;
the second switching element has a control end coupled to a second switching signal terminal, a first end coupled to the first capacitor, and a second end coupled to the light emitting element, and is configured to transmit a voltage signal in the first capacitor to the light emitting element in response to a second switching signal; and
wherein the first switching signal and the second switching signal are co-frequency inversion signals.

7. The pixel driving circuit according to claim 5, wherein the pixel driving circuit further comprises a second capacitor between the control node and the first switching element, and a third capacitor between the second switching element and the light emitting element.

8. The pixel driving circuit according to claim 6, wherein the pixel driving circuit further comprises a second capacitor between the control node and the first switching element, and a third capacitor between the second switching element and the light emitting element.

9. The pixel driving circuit according to claim 2, wherein all of transistors are N-type transistors or P-type transistors.

10. The pixel driving circuit according to claim 1, wherein the light emitting element comprises any one of a light emitting diode, an organic light emitting diode, and a polymer light emitting diode.

11. A pixel driving method, configured to drive a pixel driving circuit, wherein the pixel driving circuit comprises:
a current generating sub-circuit, coupled to a control node and a first power signal terminal, and configured to output a preset current to the control node;
a source following sub-circuit, coupled to a data signal terminal, a second power signal terminal, and the control node, and configured to change a voltage of the control node to follow a voltage of a data signal under an action of the preset current; and
a light emitting element, connected between the control node and the first power signal terminal to emit light under an action of the voltage of the control node, and
wherein the pixel driving method comprises:
outputting the preset current to the control node;
changing the voltage of the control node to follow the voltage of the data signal under the action of the preset current; and
emitting, by the light emitting element, light under the action of the voltage of the control node.

12. The pixel driving method according to claim 11, wherein outputting the preset current to the control node comprises:
generating and transmitting the preset current to the control node by using a voltage controlled transistor in response to a voltage control signal.

13. The pixel driving method according to claim 11, wherein outputting the preset current to the control node comprises:
transmitting the preset current generated by an external current source to the control node by using a switching transistor in response to a scan control signal.

14. The pixel driving method according to claim 11, wherein changing the voltage of the control node to follow the voltage of the data signal under the action of the preset current comprises:
equipotentially changing the voltage of the control node to follow the voltage of the data signal by using a source following transistor under the action of the preset current.

15. The pixel driving method according to claim 12, wherein the pixel driving method further comprises:
transmitting and storing a voltage signal of the control node to a first capacitor by using a first switching element in response to a first switching signal; and
transmitting a voltage signal in the first capacitor to the light emitting element by using a second switching element in response to a second switching signal.

16. The pixel driving method according to claim 13, wherein the pixel driving method further comprises:
transmitting and storing a voltage signal of the control node to a first capacitor by using a first switching element in response to a first switching signal; and
transmitting a voltage signal in the first capacitor to the light emitting element by using a second switching element in response to a second switching signal.

17. The pixel driving method according to claim 11, wherein the light emitting element comprises any one of a light emitting diode, an organic light emitting diode, and a polymer light emitting diode.

18. A display device, comprising:
a plurality of pixels; and
a pixel driving circuit, configured to drive the plurality of pixels,
wherein the pixel driving circuit comprises:
a current generating sub-circuit, coupled to a control node and a first power signal terminal, and configured to output a preset current to the control node;
a source following sub-circuit, coupled to a data signal terminal, a second power signal terminal, and the control node, and configured to make a voltage of the control node change to follow a voltage of a data signal under an action of the preset current; and
a light emitting element, connected between the control node and the first power signal terminal to emit light under an action of the voltage of the control node.

19. The display device according to claim 18, wherein the current generating sub-circuit comprises:
a voltage controlled transistor having a control terminal coupled to a voltage control signal terminal, a first end coupled to the first power signal terminal, and a second end coupled to the control node, and configured to generate and transmit the preset current to the control node in response to a voltage control signal.

20. The display device according to claim 18, wherein the source following sub-circuit comprises:
a source following transistor having a control end coupled to the data signal terminal, a first end coupled to the second power signal terminal, and a second end coupled to the control node, and configured to equipotentially change the voltage of the control node to follow the voltage of the data signal under the action of the preset current.
